(19) United States
(12) Patent Application Publication
(10) Pub. No.: US 2001/0015341 A1
(43) Pub. Date: Aug. 23, 2001

(54) Tamper evident closure

(76) Inventor: Phillip Higgins, Victoria (AU)

Correspondence Address: DENNISON, MESEROLE SCHEINER, SCHULTZ, Suite 612, 1745 Jefferson Davis Highway, Arlington, VA, 22202, US

(21) Appl. No.: 09/734,037

(22) Filed: Dec. 12, 2000

(30) Foreign Application Priority Data
Nov. 26, 1999 (AU) PQ3658

(51) Int. Cl. B65D 41/34; B29C 41/42; B29D 1/00; B29C 45/40

(52) U.S. Cl. 215/252; 264/334; 425/441

(57) ABSTRACT

A tamper evident closure formed from a plastics material is disclosed. The closure includes at top wall (3) and a downwardly depending skirt (5) that has an internal thread (7) adapted to engage an external thread (15) on a neck (13) of a container (11). The closure further includes a tamper evident member (9) which includes bridges (27) that connect the member to the skirt. The tamper evident member further includes a side wall that has a series of openings (21) and a plurality of tab members (33) which are connected to the side wall and extend upwardly and inwardly within a space defined by the closure and inwardly of the openings (as viewed from outside the closure). A mould assembly and a method of moulding the closure are also disclosed.

The present invention relates to tamper evident closures for containers.

The present invention also relates to a method of moulding tamper evident closures.

A known tamper evident closure that is moulded from plastics material is characterised by a series of tabs (often referred to as “petals”) that are connected via flexible hinges to a lower edge of a tamper evident band and extend upwardly and inwardly of the band. The tamper evident band is connected via bridges to the remainder of the closure. The tabs are provided to engage an undercut surface of an external bead on a container neck when the closure is in a closed position. With this arrangement, the action of unscrewing the closure from the container for the first time brings the tabs into contact with the external bead and the bead prevents further upward movement of the tabs. Continued unscrewing of the closure beyond this point progressively places the bridges under tension and severs the bridges and thereby separates the tamper evident band from the remainder of the closure. The above-described tamper evident closure is often referred to as the “J-band” closure.

Another known tamper evident closure, which was a forerunner to the J-band closure, includes a bead or a series of tabs that extend inwardly from a lower section of a tamper evident band. As with the J-band closure, the bead/tabs are provided to contact an undercut surface of an external bead on a container neck. Further, as with the J-band closure, the tamper evident band is connected via bridges to the remainder of the closure. Unlike the J-band closure, the bead/tabs are not connected by hinges to the tamper evident band. As a consequence, the bead/tabs are relatively rigid. The hinge connection of the J-band tabs makes the tabs relatively flexible, and this is an advantage of the J-band closure over this other known closure because it means that lower forces are required to apply the closure to a container neck after the container has been filled with product in a filling line.

As far as the applicant is aware, there are no known methods of moulding the J-band closure from plastics material with the tabs in an operative position, ie with the tabs extending upwardly and inwardly. The applicant is only aware of methods of moulding the J-band closure which include the steps of:

(a) moulding the closure with the tabs in a downward and inward orientation;

(b) releasing the moulded closure from the mould; and

(c) thereafter folding the tabs upwardly and inwardly into the operative position.

The requirement of step (c) to fold the tabs places structural constraints on the tabs and the closure generally. The folding step is also an additional manufacturing step and a disadvantage on this basis.

An object of the present invention is to provide an improved structure of a J-band type tamper evident closure.

A further object of the present invention is to provide an improved method and apparatus for moulding a J-band type tamper evident closure.

According to the present invention there is provided a tamper evident closure formed from a plastics material which includes:

(a) a top wall;

(b) a downwardly depending skirt that has an internal thread adapted to engage an external thread on a neck of a container; and

(c) a tamper evident member which includes bridges that connect the member to the skirt, which tamper evident member further includes a side wall that has a series of openings and a plurality of tab members which are connected to the side wall and extend upwardly and inwardly within a space defined by the closure and inwardly of the openings (as viewed from outside the closure).

Preferably the openings are spaced-apart around the side wall.

Preferably the side wall includes a band which forms a lower edge of the openings.

Preferably the side wall includes a plurality of posts which extend upwardly from the band and define side edges of the openings.

Preferably the bridges extend from upper ends of the posts.

Preferably each tab member has a base that connects the tab member to the side wall.

Preferably each tab member is formed so that the base is flexible and the tab members can bend at the base outwardly from the as-formed upward and inward orientation of the tab members.

Preferably each base has a smaller thickness than the remainder of the tab members, whereby the smaller thickness makes each base flexible.

Preferably the tab members are connected to the lower edges of the openings.

Preferably the closure is moulded from a polyolefin.

According to the present invention there is also provided a mould assembly for moulding a closure of the type described above, which mould assembly includes a central core and at least two insert slides that are movable into a moulding position in which the core and the insert slides define a mould cavity for at least part of the tamper evident member.

Preferably the central core is upstanding and the insert slides are movable horizontally.

More preferably each section of the core that forms part of the mould cavity for one of the tab members of the tamper evident member includes a first surface that tapers downwardly and inwardly and a second surface that is below the first surface and tapers downwardly and outwardly. The second surface defines a mould cavity surface which forms, in use, an inner surface of the tab member. The first surface defines a release surface for a tab member that has been moulded in the mould cavity. Specifically, in use, the tab member contacts and moves against the release surface as a closure stripper assembly moves the moulded closure upwardly to release the closure from the core. The contact of the tab member against the tapered release surface deflects the tab member outwardly to facilitate release of the closure from the core.

Preferably each section of each insert slide that forms part of the mould cavity for one of the tab members includes:

(a) a first surface that tapers downwardly and outwardly in a manner that is complimentary to the release surface of the core and contacts the release surface when the insert slide is in the moulding position;

(b) a second surface that extends outwardly and downwardly and defines a mould cavity surface which forms, in use, an outer surface of the tab member; and

(c) an intermediate surface which interconnects a lower edge of the first surface and an upper edge of the second surface and defines a mould cavity surface which forms, in use, an upper edge of the tab member.

According to the present invention there is also provided a method of moulding a closure of the type described above using the above-described mould.

The present invention is described further by way of example with reference to the accompanying drawings, of which:

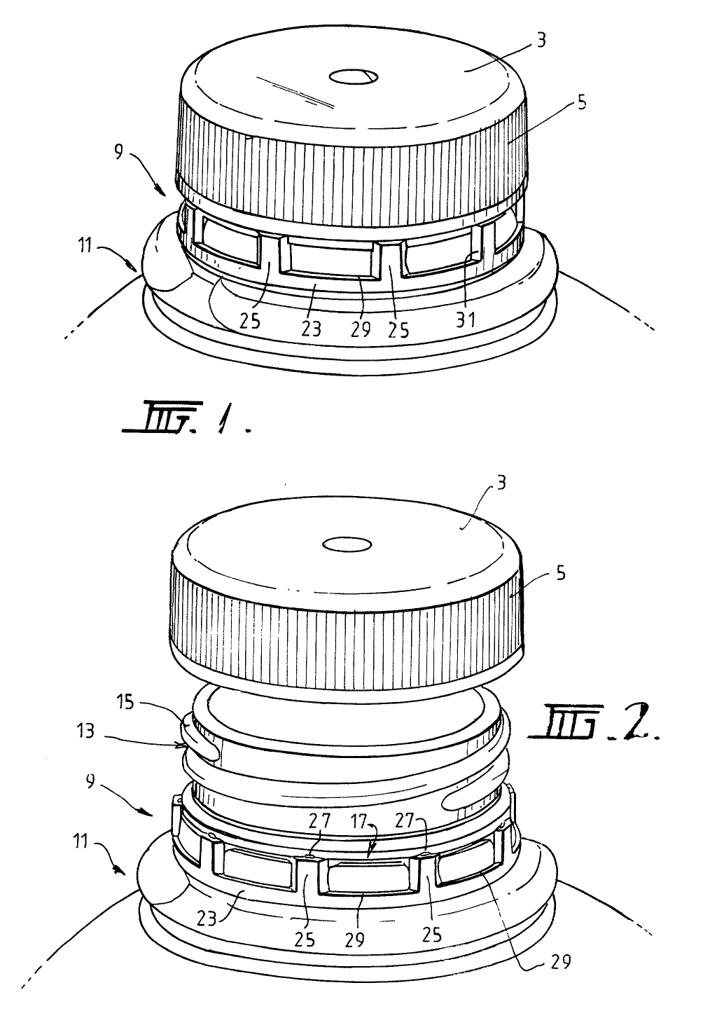

FIG. 1 is a perspective view of one embodiment of a tamper evident closure in accordance with the present invention, in a closed position;

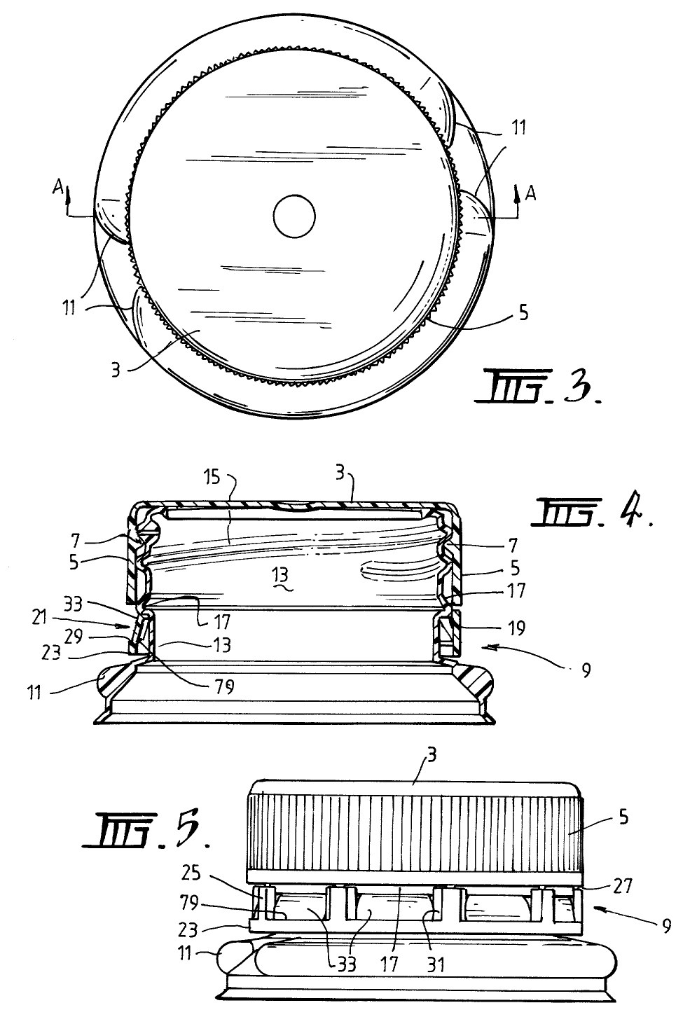

FIG. 2 is a perspective view of the closure in an open position, with the tamper evident member retained on the container neck and the remainder of the closure released from the container;

FIG. 3 is a top plan view of the closure in a closed position on the container;

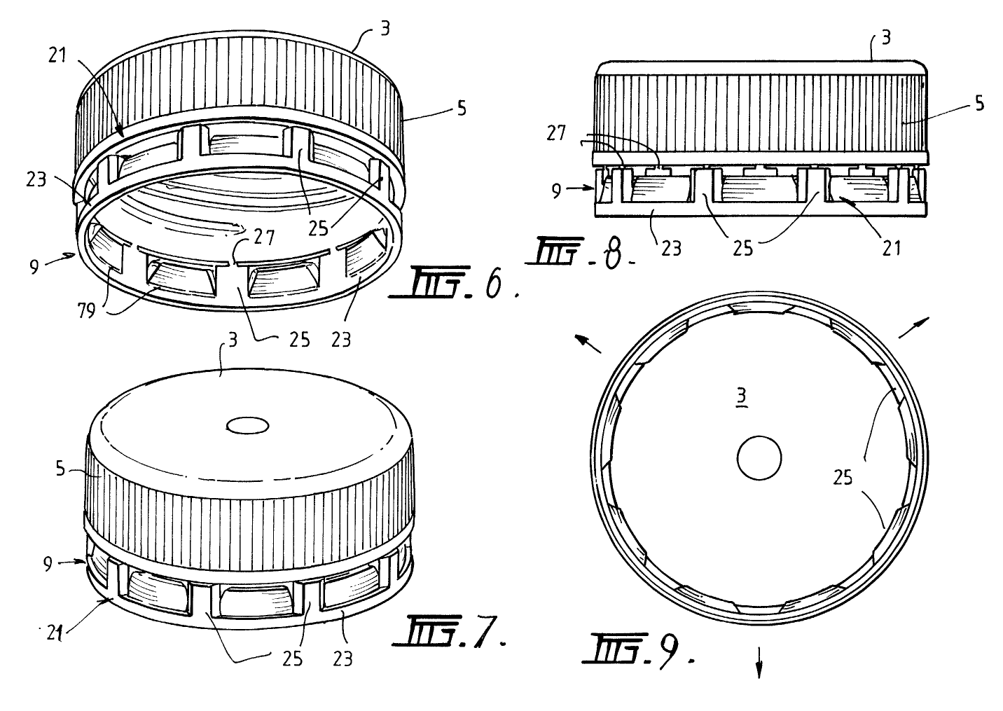

FIG. 4 is a section along the line A-A of FIG. 3;

FIG. 5 is a side elevation of the closure in a closed position on the container;

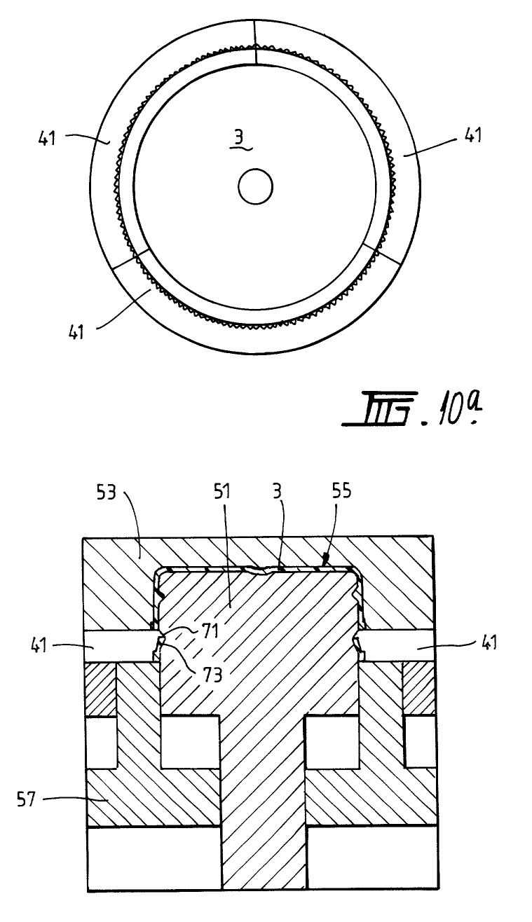

FIGS. 6 and 7 are perspective views of the closure;

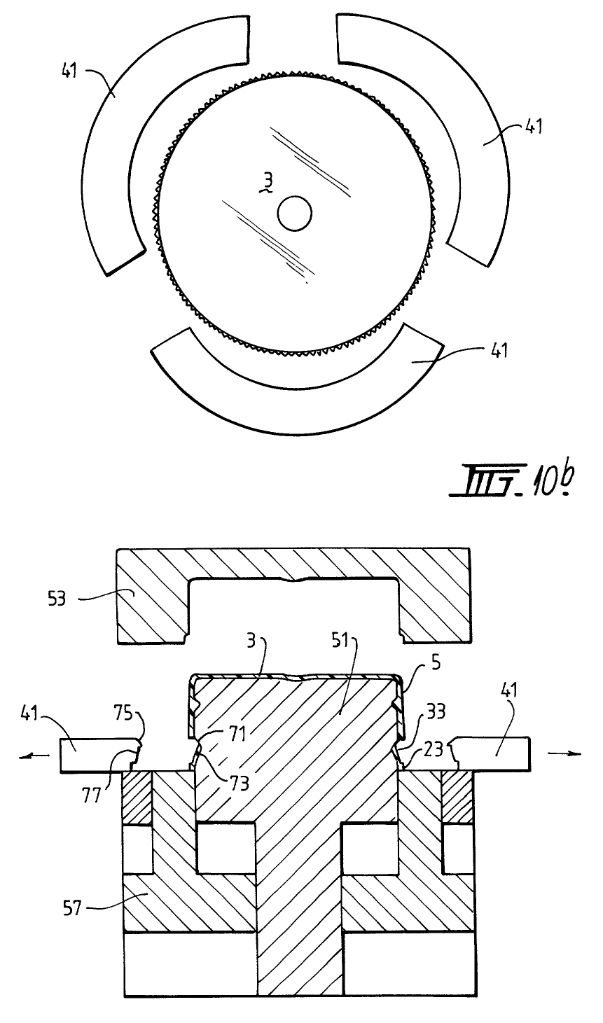

FIG. 8 is a side elevation of the closure;

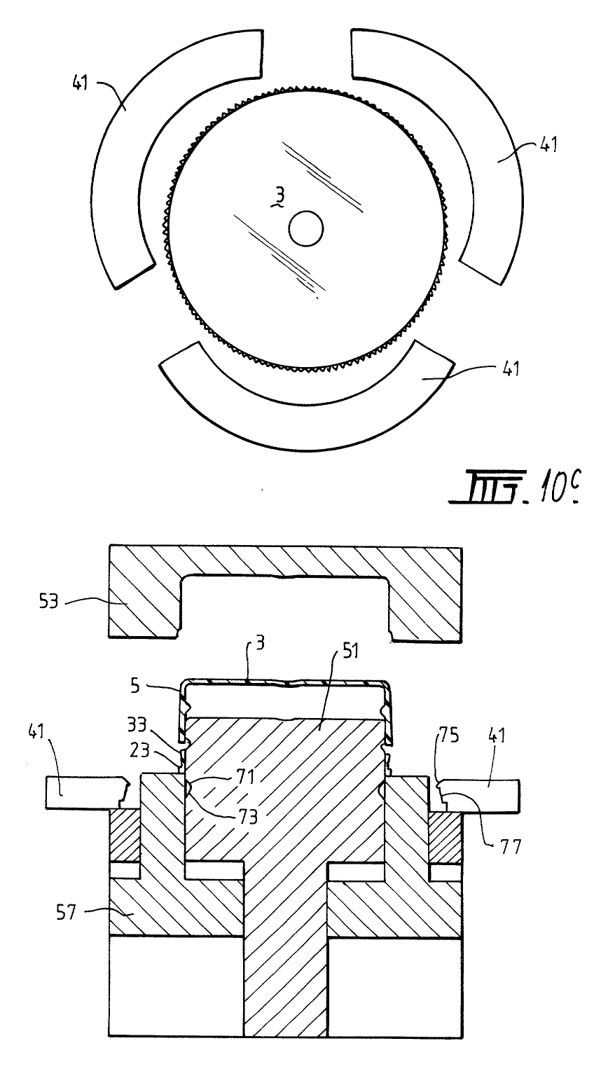

FIG. 9 is a top plan view of the closure with the top wall removed and arrows indicating the direction of movement of three-way split insert slides for moulding the tamper evident member from plastics material;

FIGS. 10a to 10d illustrate an embodiment of a moulding sequence in accordance with the present invention for moulding the closure shown in FIGS. 1 to 9;

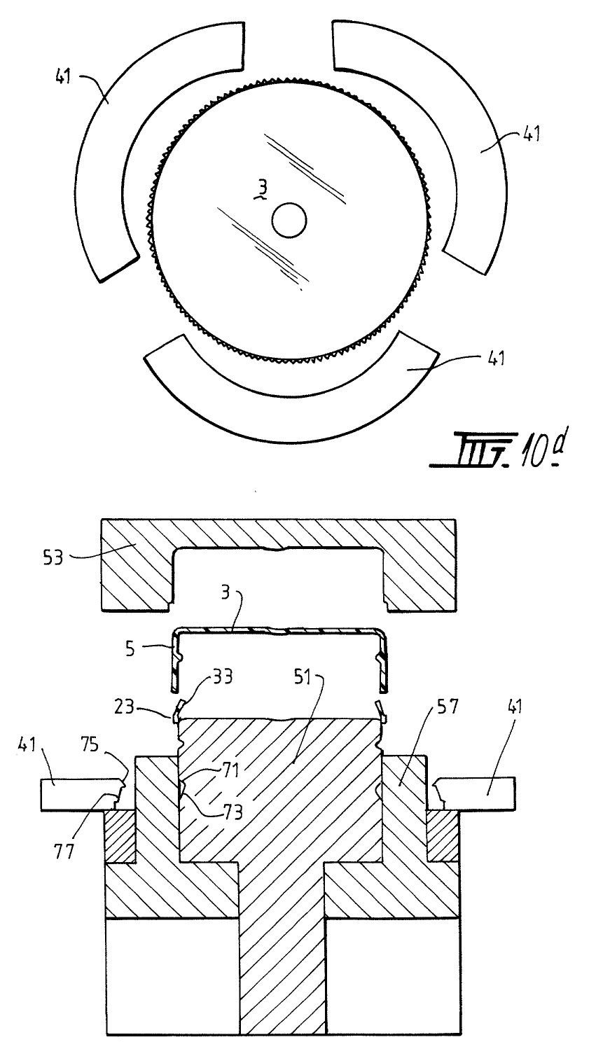

FIGS. 11 and 12 are perspective views of another embodiment of a closure formed in accordance with the present invention with the arrows in FIG. 11 indicating the direction of movement of two-way split insert slides for moulding the tamper evident member from plastics material;

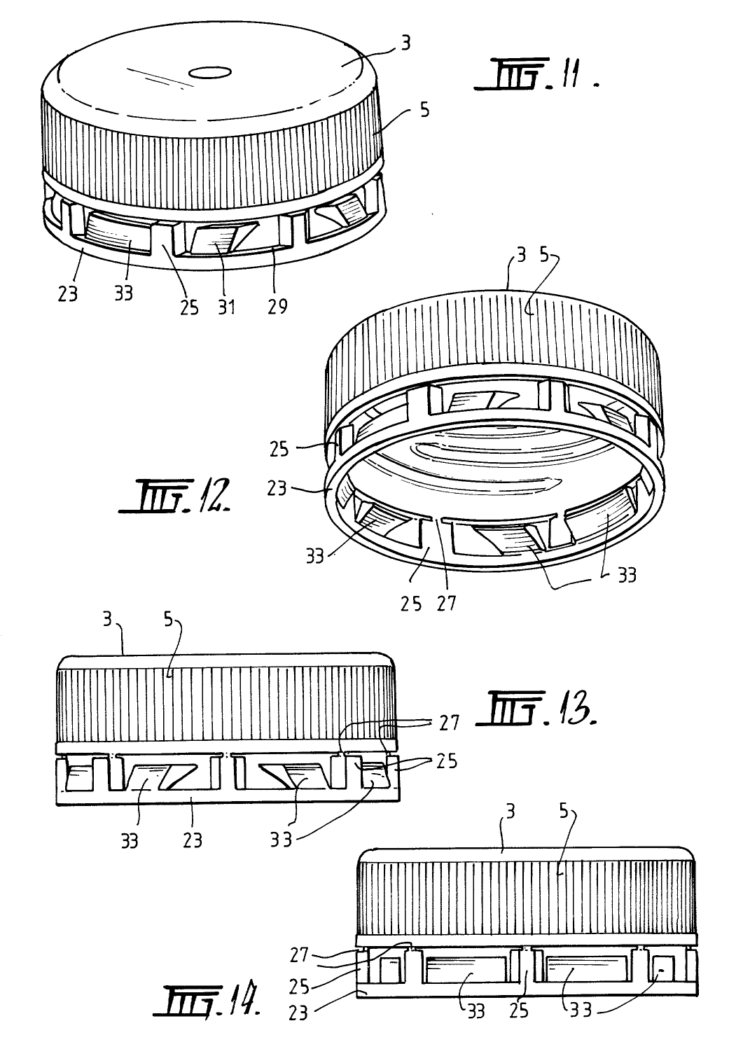

FIG. 13 is a side elevation of the closure; and

FIG. 14 is a further side elevation of the closure rotated 90°.

The closure shown in the FIGS. 1 to 9 may be moulded from polyethylene or polypropylene or any other suitable plastics material.

The closure is adapted to close a container 11. The container 11 includes a neck 13 having an external thread 15 and an external circumferential bead 17 positioned below the threaded section. The bead 17 has an undercut surface 19 (FIG. 4) that, in use, retains a tamper evident member of the closure on the container neck 13.

With general reference to FIGS. 1 to 9, the closure includes a top wall 3, a downwardly depending skirt 5 that has an internal thread 7 (FIG. 6), and a tamper evident member, generally identified by the numeral 9 .

The tamper evident member 9 includes a downwardly depending side wall that has a series of openings 21. The openings may be of any suitable size and spacing. The side wall includes a lower band 23 which defines lower edges 29 of the openings 21 and a series of posts 25 which extend perpendicular to the band 23 and define side edges 31 of the openings 21.

The tamper evident member 9 also includes a series of bridges 27 which extend from upper edges of the posts 25 and connect the tamper evident member to the skirt 5. With this arrangement, the lower edge of the skirt 5 defines upper edges of the openings 21.

The tamper evident member 9 also includes a plurality of tabs 33 which extend upwardly and inwardly into the space defined by the closure. As can best be seen in FIG. 4, the tabs 33 extend from the lower edges 29 of the openings 21. Each tab 33 has a base 79 that connects the tab 33 to the lower edge 29 of one of the openings 21. The tabs 33 are tapered such that the thickness of tab 33 increases from the base 79 to the terminal end of the tab 33. The relatively small thickness of each base 79 to the remainder of the tabs 33 makes each tab 33 flexible at the base 79 outwardly from the as-formed positions shown in the Figures. This is an important feature in the context of initially positioning the closure on the container 11. The number of tabs 33 is the same as the number of openings 21, and one tab 33 is positioned inwardly of each opening 21—as viewed from outside the closure. It is noted that the present invention does not require that there be one tab 33 for each opening 21. The tabs 33 are provided to contact the undercut surface 19 of the bead 17 on the container neck 13 and thereby prevent removal of the tamper evident member 9 from the container neck 13. The tabs 33 may be of any suitable size and shape, subject to the requirement that the tabs 33 be the same size as or smaller than the openings 21.

The closure shown in FIGS. 1 to 9 is designed so that it can be moulded using 3 way split slider inserts 41 (FIGS. 10a to 10d) to form the tamper evident member 9 of the closure. The movement of the slider inserts 41 is indicated by the arrows in FIG. 9. The positions of the slider inserts 41 and of the other components of a mould assembly for moulding the closure at 4 points in time in the moulding sequence are illustrated by FIGS. 10a to 10d.

Each of FIGS. 10a to 10d includes an upper sketch and a lower sketch. FIG. 10c also includes an additional sketch on the left hand side of the sheet. The upper sketch of each figure is a top plan view which illustrates the position of the slider inserts 41 relative to the remainder of the mould assembly at that point in time of the moulding sequence. The lower sketch of each figure is a section along the line A-A of the upper sketch and shows the positions of the components of the mould assembly at that point in time of the moulding sequence.

FIG. 10a illustrates the mould assembly in the “moulded” position. In this position, the components of the mould assembly define a closed mould cavity 55. The hatched section within mould cavity 55 indicates that plastics material has been injected into the mould cavity and formed a closure. The mould assembly components include an upright central core 51, 3 horizontally movable insert sliders 41, and an upper mould cover 53. These components define the mould cavity 55. In particular, the central core 51 and the insert sliders 41 define the mould cavity for the tamper evident member 9 of the closure. The mould assembly components also include a vertically movable stripper member 57 for releasing the moulded closure from the mould assembly.

FIG. 10b illustrates an early stage of releasing a moulded closure from the mould assembly. Specifically, this stage includes moving the slider inserts 41 outwardly so that they are clear of the upward vertical path of the stripper member 57 and moving the mould cover 53 vertically clear of the closure.

FIG. 10c illustrates a later stage of releasing the moulded closure from the mould assembly. In this stage the stripper member 57 moves vertically upwardly and contacts the lower edge of the moulded closure and pushes the closure upwardly clear of the core 51. As is described in more detail hereinafter, the core 51 is formed so that the inwardly directed moulded tabs 33 of the closure can be biased outwardly from the as-moulded position without becoming caught on the core 51 as the closure is pushed upwardly by the stripper member 57.

FIG. 10d illustrates a final stage of releasing the moulded closure from the mould assembly. At the point shown in the figure the tabs 33 are clear of the core 51 and, in view of the inherent resilience of the plastics material, spring back to the as-moulded upwardly and inwardly facing position. The figure illustrates the “release” position from which the closure can be transferred from the mould assembly.

In order to form the openings 21 and the tabs 33 of the tamper evident member of the closure:

(a) at spaced intervals around the circumference, the core 51 includes a series of downwardly and inwardly angled surfaces 71 and downwardly and outwardly angled surfaces 73 which form a series of circumferentially spaced cut-outs or notches in the otherwise generally cylindrical core 51; and

(b) the corresponding sections of the slider inserts 41 include upper surfaces 75 which are complementary to upper surfaces 71 of the core 51 and lower surfaces 77 which are complementary to the lower surfaces 73 of the core 51.

The pairs of surfaces 71, 75 and 73, 77 are complementary in the sense that the surfaces 71, 75 contact each other when the slider inserts 41 are in the moulded position shown in FIG. 10a and in the sense that the surfaces 73, 77 define inner and outer mould cavity surfaces for the tabs 33.

In addition, the angled upper surfaces 71 of the core 51 enable the tabs 33 of the moulded closure to be biased outwardly as the closure is being released from the core 51 by the stripper member 57. In this connection, preferably the upper surfaces 71 are between 10 and 40° to the vertical.

The embodiment of the closure shown in FIGS. 11 to 14 is structurally very similar to that shown in FIGS. 1 to 10. The only differences are as a consequence of designing the closure for moulding using 2 way split slider inserts.

The above-described closure has a number of advantages.

1. Providing openings 21 in the side wall of the tamper evident member 9 makes it possible to reduce the material requirements for the closure.

2. Aligning the tabs 33 with the openings 21, whilst necessary from the viewpoint of moulding the closure, also has the advantage of allowing direct access to the tabs 33. This is important in terms of preventing entrapment of liquid, such as milk (or other liquid) overspill or water entrapment during washing of the closure.

3. A further advantage of the alignment of the tabs 22 and the openings 21 is that the side wall does not restrict outward movement of the tabs 33 that is required when the closure is being applied to a container neck 13 after the container has been filled with the product. This feature, and the construction of the flexible base 79 of each tab 33, means that it is expected that the closure will require significantly lower application forces than the J-band closure.

Many modifications may be made to the preferred embodiment of the present invention described above without departing from the spirit and scope of the invention.

The claims defining the invention are as follows:

1. A tamper evident closure formed from a plastics material which includes:
(a) a top wall;
(b) a downwardly depending skirt that has an internal thread adapted to engage an external thread on a neck of a container; and
(c) a tamper evident member which includes bridges that connect the member to the skirt, which tamper evident member further includes a side wall that has a series of openings and a plurality of tab members which are connected to the side wall and extend upwardly and inwardly within a space defined by the closure and inwardly of the openings (as viewed from outside the closure).

2. The closure defined in claim 1 wherein the openings are spaced-apart around the side wall.

3. The closure defined in claim 1 or claim 2 wherein the side wall includes a band which forms a lower edge of the openings.

4. The closure defined in any one of the preceding claims wherein the side wall includes a plurality of posts which extend upwardly from the band and define side edges of the openings.

5. The closure defined in claim 5 wherein the bridges extend from upper ends of the posts.

6. The closure defined in any one of the preceding claims wherein each tab member has a base that connects the tab member to the side wall.

7. The closure defined in claim 6 wherein each tab member is formed so that the base is flexible and the tab members can bend at the base outwardly from the as-formed upward and inward orientation of the tab members.

8. The closure defined in claim 7 wherein each base has a smaller thickness than the remainder of the tab members, whereby the smaller thickness makes each base flexible.

9. The closure defined in any one of the preceding claims wherein the tab members are connected to the lower edges of the openings.

10. A mould assembly for moulding the closure defined in any one of the preceding claims, which mould assembly includes a central core and at least two insert slides that are movable into a moulding position in which the core and the insert slides define a mould cavity for at least part of the tamper evident member.

11. The mould assembly defined in claim 10 wherein the central core is upstanding and the insert slides are movable horizontally.

12. The mould assembly defined in claim 10 or claim 11 wherein each section of the core that forms part of the mould cavity for one of the tab members of the tamper evident member includes a first surface that tapers downwardly and inwardly and a second surface that is below the first surface and tapers downwardly and outwardly, whereby the second surface defines a mould cavity surface which forms, in use, an inner surface of the tab member and the first surface defines a release surface for a tab member that has been moulded in the mould cavity whereby, in use, the tab member contacts and moves against the release surface as a closure stripper assembly moves the moulded closure upwardly to release the moulded closure from the core and the contact of the tab member against the tapered release surface facilitates release of the closure from the core.

13. The mould assembly defined in claim 12 wherein each section of each insert slide that forms part of the mould cavity for one of the tab members includes:
(a) a first surface that tapers downwardly and outwardly in a manner that is complimentary to the release surface of the core and contacts the release surface when the insert slide is in the moulding position;
(b) a second surface that extends outwardly and downwardly and defines a mould cavity surface which forms, in use, an outer surface of the tab member; and
(c) an intermediate surface which interconnects a lower edge of the first surface and an upper edge of the second surface and defines a mould cavity surface which forms, in use, an upper edge of the tab member.

14. A method of moulding the closure defined in any one of claims 1 to 9 using the mould assembly defined in any one of claims 10 to 13.
